(19) United States
(12) Patent Application Publication
(10) Pub. No.: US 2005/0225776 A1
(43) Pub. Date: Oct. 13, 2005

(54) Method and arrangement for improving measuring quality during the operation of electro-optical mixing devices

(76) Inventors: Peter Gulden, Munchen (DE); Martin Vossiek, Hildesheim (DE)

Correspondence Address: YOUNG & THOMPSON, 745 SOUTH 23RD STREET, 2ND FLOOR, ARLINGTON, VA, 22202, US

(21) Appl. No.: 10/506,628

(22) PCT Filed: Feb. 24, 2003
(86) PCT No.: PCT/DE03/00580

§ 371 Date: May 5, 2005

(30) Foreign Application Priority Data
Mar. 7, 2002 (DE) 102100381

(51) Int. Cl. G01B 11/24

(52) U.S. Cl. 356/601

(57) ABSTRACT

The invention relates to arrangements and methods for improving the signal and transmission properties of laser/electro-optical mixers (EOM) of measuring and data transmission links. The idea of attempting to suppress coherent properties of laser light is novel since, until now, the aim has always been to obtain the greatest possible coherence or coherence length in most technical applications. The invention has the following features: suppressing coherence and intensity fluctuations in the beam path of laser EOM by using optical methods and suppressing the coherence in the output radiation of the laser source, e.g. by a remodulated current pulse modulation or excitation of a number of modes within a laser diode (VCSEL).

The invention relates to a method and arrangement for improving the measuring quality during the operation of electro-optical mixing devices.

In many applications of the prior art it is advantageous that an even intensity distribution to a photo-sensitive layer or a standard photodetector is provided, for example, in an arrangement in which two semiconductors separated from one another are illuminated to an equal degree. However, by using a laser beam, a high degree of accuracy is indeed obtained with the measuring method, but there are also disadvantages such as the generation of a “speckle” pattern by means of which information about the system to be measured or a data transmission is lost. In order to eliminate these interferences, methods are used, for example, that reduce the coherence of the laser beam and, thereby enabling a homogenous intensity distribution to photo-sensitive layers.

The prior art for suppressing the coherence of a light beam on a transmitting side is summarized in [1]. A scattering used to suppress the coherence can take place in the transmitter optics for example by using an optical fiber with a high dispersion, corresponding deformation of an optical fiber [2] or by using a “diffractive optical element” according to [3]. There are also several possibilities of suppressing the coherence directly on the laser diode. The current flowing through the laser diode is mostly modulated for generating an intensity modulation of the laser diode. Therefore, it is now possible by means of specific features on the modulation voltage to allow the laser diodes to no longer emit or only to emit with restricted coherence. The first possibility is thus the use of Very Large Capacity Surface Emitting Laser Diodes (VCSEL). Should these be operated with a relatively high power output, then they go over to the multimode operation and in this way lose the coherence. However, in previous applications of VCSEL, this characteristic is viewed as disadvantageous.

The use of laser diodes that can be intensity-modulated with the highest frequency is also particularly advantageous in systems that include electro-optical mixers (EOM) such as metal semiconductor metal structures [4] [5] [6] or photonic mixing elements according to [7] because they facilitate a considerable increase in the data rate in digital communication systems and in distance measuring systems according to [5, 8] and also considerably increase the degree of accuracy because of their large bandwidth.

Unfortunately, measurements in methods that use electro-optical mixers such as PMD or MSM have systematic errors, the causes of which are unknown. Communication systems that use electro-optical mixers are digital and have bit errors. Measuring errors can also be detected in analog distance/speed measuring methods that use electro-optical mixers.

At present, there is no known teaching by means of which output signals with interferences can be eliminated during the operation of an electro-optical mixer.

The invention described below is based on the knowledge that innovative electro-optical mixers have interference products in the output signal under certain circumstances which usually depend on the interaction of the physical properties of the semiconductor and the illumination intensities with local differences. In greater detail it has become known that site-dependent variations of the illumination intensity in electro-optical mixers lead to AC interferences and that these interferences adversely affect the different measuring methods.

As a result, possible causes of these effects are load carrier injections of the interfering currents that intensify, on the basis of specific layer sequences, in the semiconductor of the electro-optical mixer. Therefore, illuminating the electro-optical mixers with slightly different intensity distributions, results in interfering signals depending on the local illumination situation that for example causes distance measuring errors. A situation with a changing illumination can for example result in a distance measuring system by changing the distance between the measuring unit and a target because in such a case, on the basis of unavoidable triangulation effects, the light spot incidence on the electro-optical mixer can easily wander. Additional intensity fluctuations of the illumination on the electro-optical mixer can also take place in fiber optical systems on the basis of the mechanical load and temperature expansion. An additional problem is the fact that during large-scale production there can be slight deviations from tolerances.

Although the prior art specifies methods to reduce interferences in methods in the case of which for example photodetectors are used, no device and method are yet known for correcting the interfering signals from electro-optical mixing devices because the effects of interfering signals and their causes have not yet been recognized in electro-optical mixing devices.

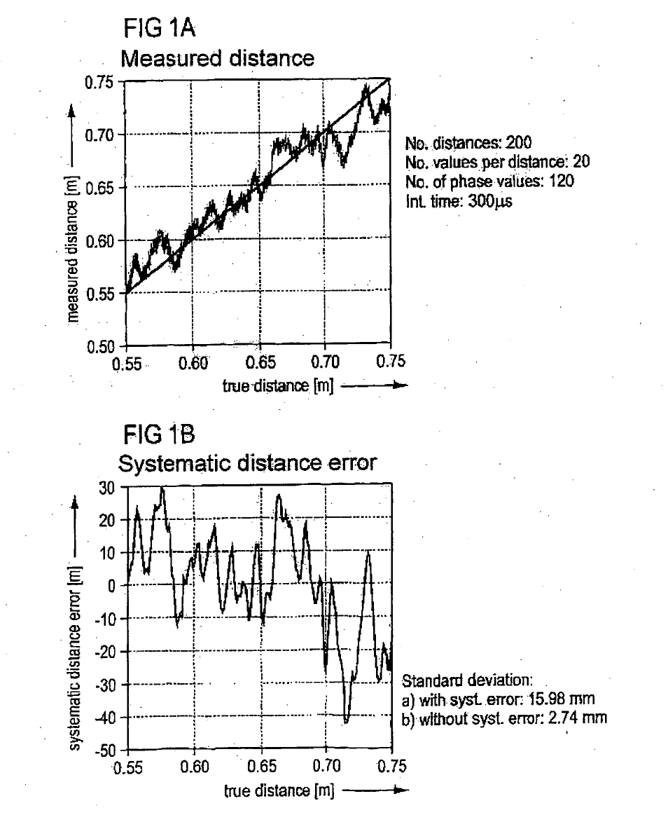

The errors that must be observed in an optical measuring method with an electro-optical mixer are shown in FIG. 1.

The knowledge, that serious measuring errors, when using electrooptical mixers are based on optical fluctuations or intensity fluctuations results in the object of specifying a method and/or a device in which the improved signal and transmission properties are achieved in electro-optical measuring systems and particularly also in measuring systems that use laser beams and electro-optical mixers.

The solution of the object of the invention will emerge from the features and the independent claims. Advantageous embodiments of the invention will emerge from the subclaims.

The object of the invention is achieved in that the coherence of a light beam used in the measuring method before incidence on an electro-optical mixer is suppressed. In addition, a suppression of intensity fluctuations that are not based on coherence is also guaranteed.

The invention characterizes itself in that contrary to the prior art, whereby the aim has always been to obtain the greatest possible coherence or coherence length in most technical applications with electro-optical mixers, the invention suppresses the coherence.

The coherence of the light beam before incidence on a photoreceiver is reduced by means of a coherence-reducing unit using a method to reduce the interfering signals in an electro-optical mixing method,

Photoreceiver means a unit having at least one electro-optical mixer. It can be embodied by receiver optics as scattering elements “DOE—diffractive optical elements”, lenses or apertures. An electro-optical mixer usually consists of mixing semiconductor elements. In other words, electro-optical mixers of this type that are manufactured on a semiconductor basis can also be used. The application of PMDs (photo-electronic mixing devices), MSM (metal-semiconductor metal) structures and/or an MSM-PMD combination is also especially preferred.

Both scattering units and units that modulate a light wave or change the modem of a light wave belong to the coherence-reducing units.

The invention can be used in a method that uses a laser beam as the light wave or beam.

The invention includes several scattering units that can be used, for example an optical fiber which is preferably used in or directly outside an optical transmitter unit in the beam path of the light beam. Further examples of scattering units are a rough layer, or a diffusing lens that is particularly used in or directly outside a photoreceiver. In principle, it is advantageous if the scattering element is possibly mounted closely in front of the photoreceiver because this reduces a loss of light efficiency.

The rough layer is applied to the optimum to a photo-sensitive layer particularly to an electro-optical mixer. In an additional embodiment of the invention, the rough layer has scattering particles and/or a rough surface. As a result, the scattering particles can then be incorporated into a scattering unit or applied as a powder to a light-sensitive layer.

The diffusing lens is used to the optimum in or directly outside the photoreceiver in the beam path of a light beam or the laser.

The electro-optical mixing device according to the invention includes in each case at least one light source, a photoreceiver and a coherence-reducing unit which reduces the coherence of a light beam. Therefore, the coherence-reducing unit suppresses the coherence of the light beam before incidence on an electro-optical mixing device.

The above-mentioned electro-optical mixing device is expanded by the fact that the photoreceiver has a housing with a previously mentioned scattering unit and a light-sensitive layer particularly an electro-optical mixer.

The invention enables a further coherence suppression by a remodulated current pulse modulation or excitation of a number of modes within a laser diode (VCSEL) which are used alone or in combination with the above-mentioned device. For this, a corresponding modulation device is provided which influences the electromagnetic properties of a light beam in a measuring or data transmission method.

The invention is explained in greater detail with reference to the accompanying drawings and embodiments, in which;

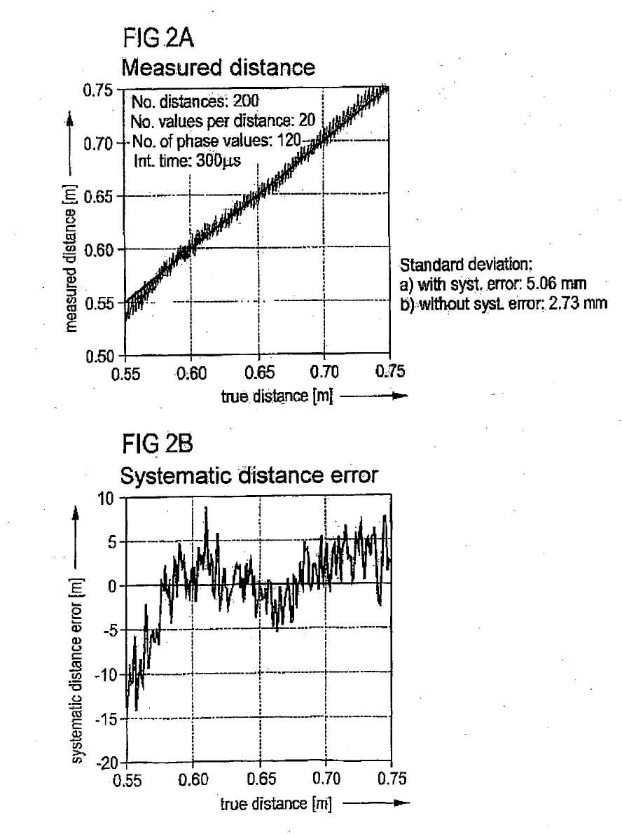

FIG. 2 shows a graph for showing the reduction of the measuring error for a distance measurement with one of the embodiments of the invention explained below

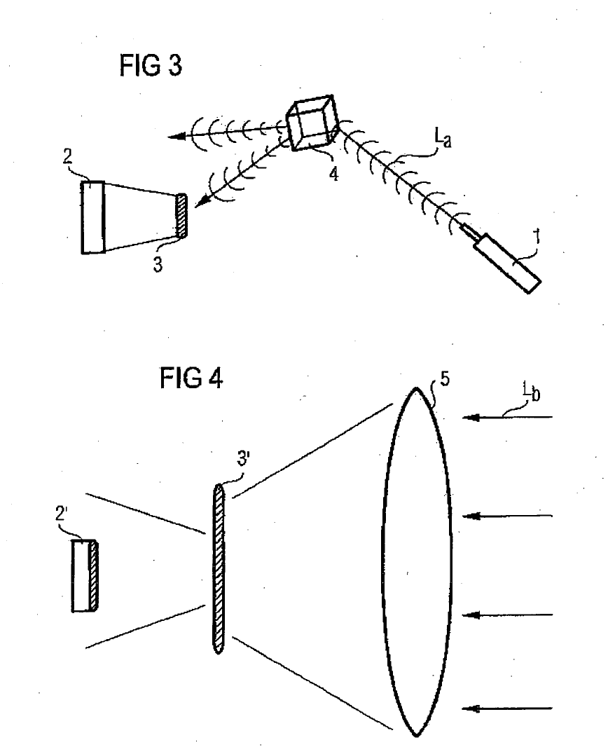

FIG. 3 shows a schematic diagram of the invention

FIG. 4 shows a diagram of the reduction in coherence on the receiver side with an EOM

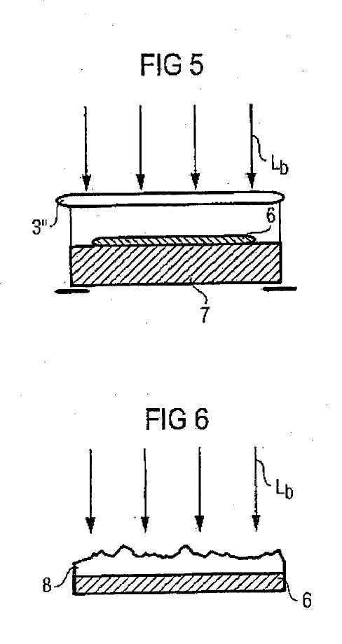

FIG. 5 shows a first exemplary device which allows a reduction in coherence on the receiver side

FIG. 6 shows a second exemplary device which enables a reduction in coherence on the receiver side.

FIG. 2 identifies the effect that is generated by replacing a device embodied according to the invention. In comparison with a system in which no reduction in coherence is shown before incidence on an electro-optical mixer [9], the standard deviation with systematic errors is less by approximately 2/3 for a distance measurement.

FIG. 3 shows a schematic arrangement that allows the above-mentioned reduction. A light source (1), for example, a laser illuminates an object (4) to be measured with a radiation Lₐ which first of all reflects from the object (4) to a photoreceiver (2) and/or is scattered partially. Before incidence of the radiation on the photoreceiver (2), the radiation is once again scattered by a coherence-reducing unit (3).

Therefore, the coherence-reducing unit (3) can be embodied as a scattering unit or as a modulation unit that modulates light waves or changes the modes of a light beam. A combination of these two units is conceivable wherein the modulation unit is preferably used on the transmitter side in front of the object (4).

FIG. 4 is a coherence-reducing diffusing lens (3′) which is arranged between a photoreceiver (2′) and a lens (5) in the beam path of the incidence light L_{b}.

FIG. 5 shows a particularly cost-effective and also low-loss embodiment of the invention wherein the scattering element (3″), for example, a diffusing lens becomes part of a housing and carrier (7) of an electro-optical mixer (6).

In the case of parallel arrangements of an electro-optical mixer on a chip, separate illumination of the individual elements must be possible despite the desired scattering. Any “transverse illumination” would drastically reduce the sharpness of the image recorded in each electro-optical mixer. In this case, the variant shown in FIG. 6 is preferred. In the case of elements encapsulated transparently in the housing, the surface (8) can be rough. A scattering coating can be applied (8) directly to an electro-optical mixer or to a photo-sensitive chip (6); said coating either with a rough surface or internally scattering particles. In this arrangement, the sharp delimitation of the illumination of individual pixels is guaranteed and the integration of the coating in the manufacturing process of the electro-optical mixer could be cost-effective.

The use of an electro-optical mixer with a wide aperture angle (volume illumination) is particularly advantageous to mount the scattering element in the optical transmitter (laser source) because this sometimes facilitates the adhering to the boundary values for eye safety in the case of laser sources (large-area source).

In principle, the wave length of a laser and thus the developing interference pattern depends on the operating current and the temperature of the laser. This can now be utilized by the fact that a clearly higher frequent portion is superimposed on the modulation current. This then takes care of small fluctuations in the laser wave length within a modulation period of the actual signal. As a result, the interference pattern changes temporarily and the interfering signals arising within a modulation period are blurred because they are much slower than the temporal change in the interference pattern.

Further possibilities for suppressing the coherence of a laser beam used in the invention is the excitation of several modes in the laser by means of suppressing different reflected light fractions of the laser light in the laser itself as well as the excitation of several modes by temperature modulation or mounting the laser chips under stress (this leads to locally different wave lengths in the laser chip) or the application of several laser diodes in an array particularly in the well-known arrangements for the possibly uniform illumination according to [10].

A laser beam provided according to the above-mentioned methods would contribute to the reduction in the illumination fluctuations on an electro-optical mixer.

The invention can use digital communication methods and optical recognition methods in for example the 3-D measuring method.

The following publications are quoted within the framework of this document:
[1] Iwai, T. and T. Asakura, Speckle reduction in coherent information processing. Proceedings of the IEEE, 1996. 84(5): p. 765-781.
[2] Kolobov, M. I., Quantum noise reduction in optical imaging of the spatial coherence of the source. Physical Review A, 1995. 51(2): p. 1656-1661.
[3] Wang, L., et al., Speckle reduction in laser projection systems by diffractive optical elements. Applied Optics, 1998. 37(10): p. 1770-1775.
[4] Shen, P. H., et al. Interdigitated finger semiconductor photodetector. in SPIE Aerosense, 24-28 April 2000. 2000: SPIE.
[5] Schwarte, R. Dynamic 3D-Vision. in IEEE Int. Symposium on Electron Devices for Microwave and Opto-electronic Applications. 2001. Vienna, Austria: IEEE.
[6] Lam, D. K. W. and R. I. MacDonald, GaAs optoelectronic mixer operation at 4.5 GHz. IEEE Transactions on Electron Devices, 1984. 31(12): p. 1766-1768.
[7] Schwarte, R., Verfahren und Vorrichtung zur Bestimmung der Phasen-und/oder Amplitudeninformationen einer elektromagnetischen Welle, in DE 197 04 496 A 1. 1997, R. Schwarte: Germany. p. 26. (Schwarte, R., Method and device for determining the phase and/or amplitude information of an electromagnetic wave, in DE 197 04 496 A 1. 1997, R. Schwarte: Germany. p. 26.)
[8] Gulden, P. G., M. Vossiek, and P. Heide, Verfahren und Anordnung zum Betrieb eines Photoelectric Mixing Devices (PMD). 2000, Siemens AG: Munich. p. 16. (Gulden, P. G., M. Vossiek, and P. Heide, Method and device for operating a photoelectronic mixing device (PMD). 2000, Siemens AG: Munich. p. 16.)
[9] Gulden, P. G., et al. Application of the Photoelectronic Mixing Device to Optical Measurement of Presence, Distance and Velocity. in EuMW. 2000. Paris: EuMW.
[10] Lohmann, A. W. and S. O. Sinzinger. Spatial Noise Reduction in Array Illuminators. in Optical Computing. 1991. Salt Lake City, Utah.

1-15. (canceled)

16. Method for reducing the interfering signals in an electro-optical measuring process whereby the coherence of a light beam is reduced before incidence on a photoreceiver (2) comprising an electro-optical mixer (6).

17. Method according to claim 16 wherein a scattering unit (3) is used to reduce the coherence.

18. Method according to claim 17 wherein an optical fiber is used as the scattering unit (3).

19. Method according to claim 17 wherein a rough layer (8) that is applied to the electro-optical mixer (6) is used as the scattering unit (3).

20. Method according to claim 17 wherein a diffusing lens is used as the scattering unit (3).

21. Method according to claim 16 wherein a current pulse modulation or excitation of several modes of a laser beam are embodied particularly within a laser diode.

22. Electro-optical mixing device with at least one light source (1) and one photoreceiver (2) wherein a coherence suppression of a laser beam before incidence on a photoreceiver (2) particularly an electro-optical mixer (6) is achieved by means of a coherence-reducing unit.

23. Device according to claim 22 wherein the coherence-reducing unit is a scattering unit (3).

24. Device according to claim 23 wherein the scattering unit (3) is an optical fiber.

25. Device according to claim 23 wherein the scattering unit (3) is a diffusing lens.

26. Device according to claim 23 wherein, a rough layer (8) is applied to a photoreceiver (2) as a scattering unit (3), particularly an electro-optical mixer (6).

27. Device according to claim 26 wherein the rough layer (8) has scattering particles and/or a rough surface.

28. Device according to claim 23 wherein a housing (7) forms the photoreceiver (2) which particularly includes the electro-optical mixer (6) and the scattering unit (3″).

29. Device according to claim 22 wherein the coherence-reducing unit is a light wave modulation unit.

30. Device according to claim 24 wherein a housing (7) forms the photoreceiver (2) which particularly includes the electro-optical mixer (6) and the scattering unit (3″).

31. Device according to claim 25 wherein a housing (7) forms the photoreceiver (2) which particularly includes the electro-optical mixer (6) and the scattering unit (3″).

32. Device according to claim 26 wherein a housing (7) forms the photoreceiver (2) which particularly includes the electro-optical mixer (6) and the scattering unit (3″).

33. Device according to claim 27 wherein a housing (7) forms the photoreceiver (2) which particularly includes the electro-optical mixer (6) and the scattering unit (3″).
